(19) United States
(12) Patent Application Publication
(10) Pub. No.: US 2001/0037221 A1
(43) Pub. Date: Nov. 1, 2001

(54) Optometric business method

(76) Inventor: Peter Slapnicher, Hastings, MN (US)

Correspondence Address: Anthony G. Eggink, Anthony G. Eggink & Associates, 3100 First National Bank Building, 332 Minnesota Street, Saint Paul, MN, 55101, US

(21) Appl. No.: 09/832,647

(22) Filed: Apr. 11, 2001

Related U.S. Application Data
(60) Provisional application No. 60/196,318, filed on Apr. 12, 2000.

(51) Int. Cl. G06F 17/60

(52) U.S. Cl. 705/3

(57) ABSTRACT

An optometric business method and a tangible informational holder provided in the business method. The method steps include the exchange of information between a patient and the clinic. The exchange of information includes patient specific information obtained by the clinic from the patient. The patient information is processed with respect to data obtained from the patient during the visit to provide an analysis based upon the needs of the patient and the services and products offered by the clinic. The patient is provided with the tangible informational holder and a plurality of inserts, including patient specific inserts, which are readily accessible to the patient and enables the patient to choose products and services.

This application claims the benefit of U.S. patent application Ser. No. 60/196,318, filed on Apr. 12, 2000.

### BACKGROUND OF THE INVENTION

The present invention relates generally to a method of doing business. More particularly, the invention relates to a method of doing business in the optometric field. The invention utilizes a tangible information holder and inserts that are provided by a business and transferred or exchanged between the business and a customer. The various inserts collectively include information identifying the particular business, educating customers about the different aspects of the business and the industry within which it operates, promoting customer goodwill, and marketing the goods and/or services the business offers for sale. More specifically, the method educates customers about the products, services, service providers, and operations of the business; describes the industry within which the business entity operates, including the industry standards, and warranties and guaranties common in the industry; and provides information about the industry or business that is potentially useful for its customers in making educated consumer choices.

The method of the present invention relates to a business method and particularly to a method of doing business in the optometric field. In the method, the patient is provided with tangible information in the course of the visit to the clinic and which includes contact with a receptionist, a doctor and an optician. Specific information and data are exchanged between the respective parties and put into a database or the like. Patient specific information is generated from the database based upon the needs, requirements and information generated and obtained during the course of the visit. The method of the invention is likewise applicable to other business fields wherein the particular parties and specific information would relate to the particular business in which the method of the invention is utilized.

Of central importance to the invention is that during this informative activity, information about the customer is obtained by the business that is entered into a database or the like, i.e. on a website accessible by the business. From this data and information, an analysis is performed about the product and service needs of the customer that can be provided by the business, and recommendations are made to the customer regarding what specific products and services would best meet the needs of the customer. In summary, the invention provides an enjoyable method by which a customer can become more informed about a business and its products and services and the business, by analyzing data gathered about a customer and his or her needs contemporaneously with a visit by the customer, can provide more individualized recommendations to the customer during the same visit The information holder or folder is given to the customer during the visit to the business, i.e., at the reception area of the business at the outset of the visit. The inserts for either providing or obtaining information are given to the customer generally at times when the customer would be waiting for assistance or for some specific event to occur, thereby occupying his or her time with potentially mutually beneficial activities.

### SUMMARY OF THE INVENTION

The present invention is a method of doing business that utilizes a tangible information holder and inserts that are provided by the business and transferred or exchanged between the business and the customer. When a customer arrives at the business, the customer is presented with an information holder. The presenter explains the purpose of the information holder and inserts, including that they are part of the business' system of quality assurance. At this time, the information holder may contain or the presenter may provide the customer with a plurality of business identification items and inserts to keep in the information holder and begin the visit. The insert or inserts are explained by the presenter individually and in the proper sequence. The first insert may contain information identifying the business, such as its name, address, hours that it is open for business, and telephone numbers. As the customer proceeds with his or her visit and comes in contact with various service providers, the customer receives additional inserts to include in the information holder. These inserts generally pertain to that area of the business currently being visited by the customer. Thus, the order that the inserts are received generally coincides with the order for providing the services that the customer is about to receive. They may be informational or request information, and may be designated to be read or completed when presented to the customer or later while the customer is waiting for the delivery of further service or a product. If information is entered on any of these inserts by a service provider or the customer, that information also may be entered into a database or the like of the business and analyzed with respect to individual service and product needs of the customer. The purpose of these inserts is likewise explained, albeit by the respective service providers giving them to the customer.

Consequently, when the customer leaves the business with the information holder and inserts in-hand, he or she will leave with a better understanding of the services and/or products that the business just provided and a higher level of satisfaction regarding those services and/or products, and the business will have a better understanding about the customer's individual needs to enable the business to more successfully market itself at the time of the visit and in the future.

For example, in the area of optometry in which a business may comprise a clinical practice and an optical practice, the informational holder or booklet and inserts may be comprised of a folder, having a clinical practice business card, an optical practice business card, a business card magnet, and a plurality of inserts which are presented to the patient generally in the order that the services will be received.

A front desk receptionist presents the folder to the patient, which may include an “optical experience” insert, a “life style packaging” insert, a “welcome insert”, and a magnet displaying clinical and optical telephone numbers. The receptionist explains that the folder and inserts are part of the business' system of quality assurance and explains the three inserts individually and in order. The patient then proceeds with his or her visit, during which the following inserts may be presented: a “contact lens” insert presented by an opthomological technician, an “eye health and vision report” insert presented by a doctor, and a “lens” insert presented by the service-provider who also consults on the “eye health and vision report” insert and on the “contact lens” insert. This service provider also reminds the patient to obtain a “fashion consultant” insert from the optical practice. Before the patient leaves, the physician presents the “eye diseases and emergencies” insert and an optician presents the “fashion consultant” insert.

These and other benefits of this invention will become clear from the following description by reference to the drawings.

### BRIEF DESCRIPTION OF THE DRAWINGS

FIG. 1 shows the information holder utilized in the business method of this invention;

FIGS. 2-9 show the inserts that are transferred or exchanged between the business entity and the customer in the method steps of this invention;

FIGS. 10-16 show further informational inserts generated from information exchanged between the parties in the method of the invention; and

FIGS. 17-24 are enlarged views of the inserts, both front and back, shown in FIGS. 2-9.

### DESCRIPTION OF THE PREFERRED EMBODIMENTS

The preferred embodiment of this invention relates to a method of doing business in the area of optometry. In particular, the invention relates to information transferred or exchanged between a business and its patients using an optometric information holder 10 and inserts 26-33 which are provided in the steps of the method.

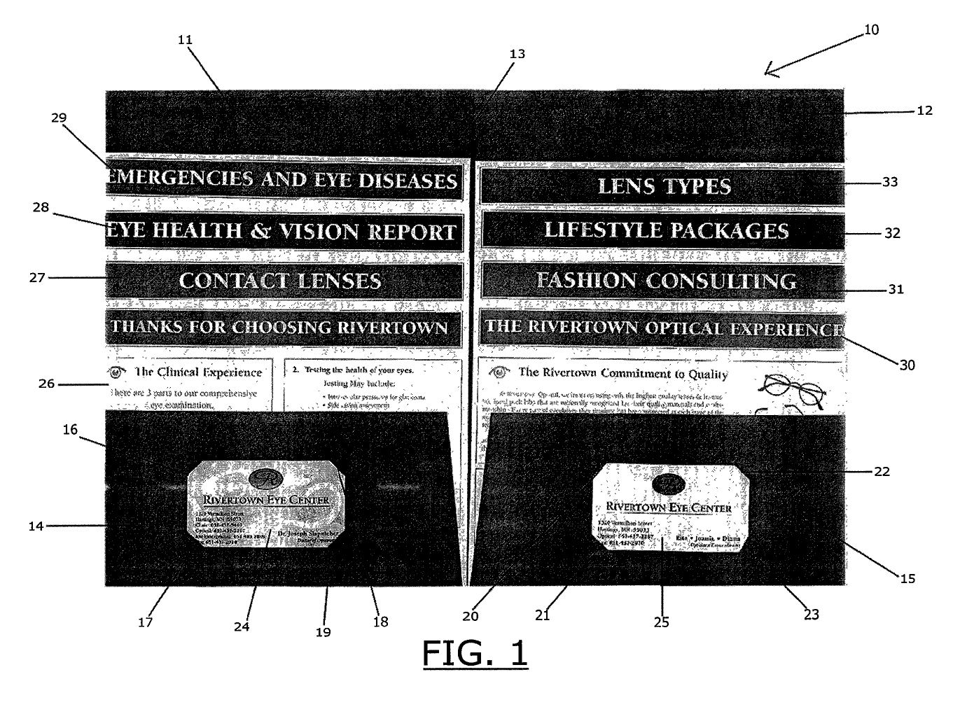

As shown in FIG. 1, the optometric information holder 10 comprises a folder having a first side 11 and a second side 12. A clinical practice business card 24 and an opticians business card 25, having business information printed upon it, such as the business' name, location, and telephone numbers. A magnetic business card having the information of card 24 may also be provided for subsequent use by the patient. The folder 10 may be approximately 12 inches in height and approximately 9 inches in width after being folded in half so that there is a left interior side 11 and a right interior side 12 of a closed folder as its front faces upward. The front of the folder 10 preferably has the name of the clinic printed thereon. The folder 10 is constructed and arranged so that when it is opened and laid flat with the inside facing upward, there is a left flap 14 on the left side and a right flap 15 on the right side of the crease 13 of the folder 10. The left flap 14 and right flap 15 each extends along and from the entire bottom edge of its respective half of the folder 10. Each flap may extend upwardly approximately 4.25 inches from the bottom of the folder 10. The outside edges of each flap are preferably united with the outside of the folder's outside edge. The inside of each flap is shown angled inwardly. The folder 10 preferably is a unitary piece made by folding a piece of construction paper, light cardboard, or similar material.

The clinical practice business card 24 is shown in FIG. 1 fixed in the left flap 14 and the optical business card 25 is shown fixed in the right flap 15. The optical business card 25 is attached in the right flap 15 inserting each of the corners of the card through angled slits 20-23 in the flap. The slits are constructed and arranged so that each slit holds one corner of the card and all the corners of the card are simultaneously held by the slits, thereby holding the card 25 in an upright position facing outward, so that it can be easily read when the folder 10 is opened. The clinical practice business card 24 is shown fixed in the left flap 14 inserting each of the corners of the card 24 through slits 16-19. Each card contains the name of the business, the business' address, its normal and emergency telephone and/or fax numbers, and the names of service providers to contact for the clinical practice and the optical practice, respectively. The magnetic optical practice business card 25 may be attached to flap 14 or an insert using a weak adhesive, such as two-sided tape or a gummy adhesive, in a manner that does not interfere with attaching the business cards to the folder.

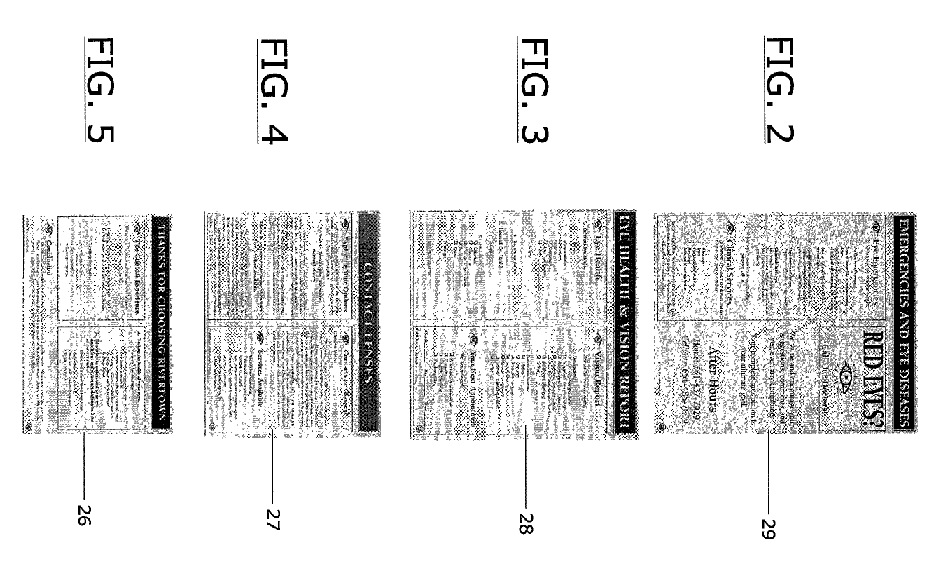

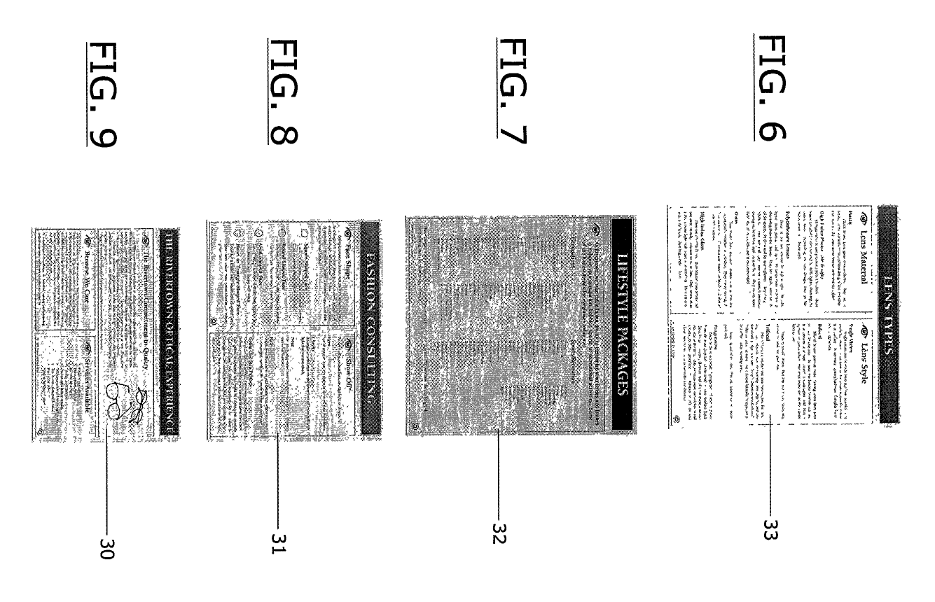

As shown in FIG. 1 the inserts 26-33 are placed into the folder 10 behind one of the flaps. Shown held on the left inside 11 of the folder 10 by and behind the left flap 14 are four inserts, namely 26-29, entitled in order from front to back, “Thanks for Choosing Rivertown” 26, “Contact Lens” 27, “Eye Health Vision Report” 28, and “Emergencies and Eye Diseases” 29. Each of these inserts is shown in FIGS. 2-5. Held on the right inside 12 of the folder 10 by and behind the right flap 15 are four inserts 30-33, entitled “The Rivertown Optical Experience” 30, “Fashion Consulting” 31, “Lifestyle Packages” 32, and “Lens Types” 33. Each insert is shown in FIGS. 6-9. The inserts 26-33 are all the same width, at least as narrow as a flap, so that collectively they do not interfere with closing the folder, and are of varying heights so that the title banner of each insert shows above the flap that it is behind and over the title banner of each other insert placed in front of it.

It is important that the method of the invention is implemented in the order of the steps set forth, so that the information is received or obtained when it is likely to be most helpful to the patient and the business. When a patient arrives at the business, the front desk receptionist gives the patient a folder 10 with a clinical practice business card 24, and an optical practice business card 25. Inside the folder 10 is an “Optical Experience” insert 30, a “Lifestyle Packaging” insert 32, and a “Welcome” insert 26. The receptionist explains that the items are part of the business' system of quality assurance and presents the three inserts in the order mentioned above. The “Optical Experience” insert 30 provides information about the quality of the business' practices, the services provided by the business, and warranties and guarantees that come with various services and/or products. The “Lifestyle Packaging” insert 32 asks the patient about his or her avocational and recreational pursuits, to assist the business in providing more individualized products and/or services.

If the patient wears or is interested in wearing contacts, he or she will next meet with the opthomological technician, who presents the “Contact Lens” insert 27, which explains about contact lens, the various options available, and the contact lens services that the business provides.

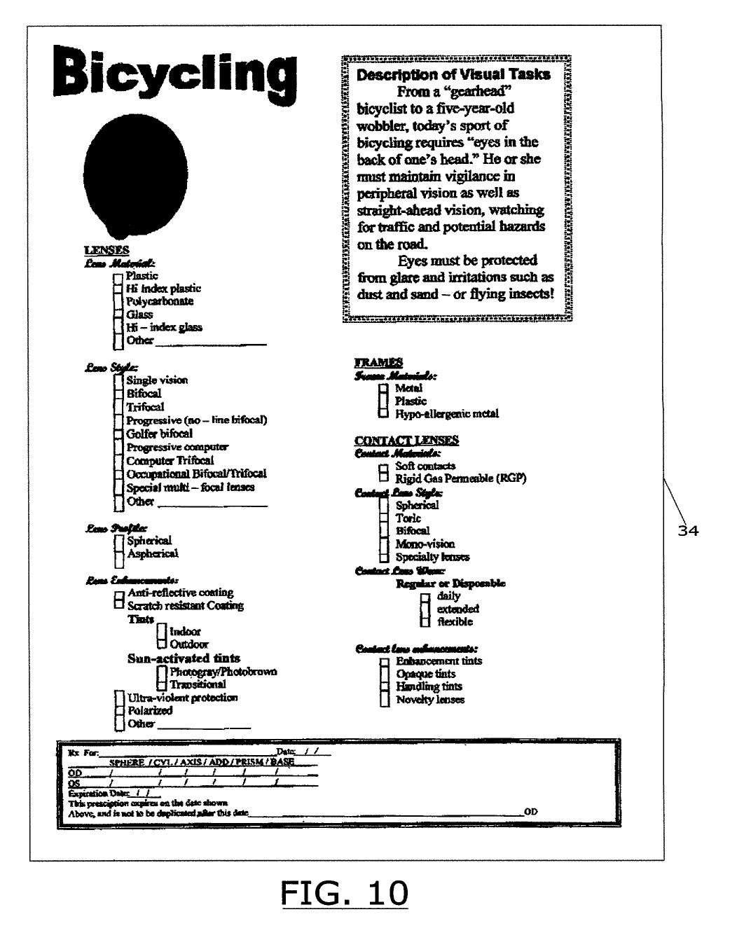

The patient then proceeds to his or her eye exam, after which the physician presents the “Eye, Health & Vision Report” insert 28 to the patient. This insert documents the doctor's findings and recommendations concerning the patient's external and internal eye health; recommendations for lenses, contacts, and frames; and recommendations for any surgery. It also includes a space for prescriptions and the suggested time for a return visit. The information from this report is also entered into the business' patient database or the like. While the patient waits for dilation eye drops to take effect, for example, he or she proceeds to the informational center where a service provider presents the “Lens Types” insert 33 concerning different types of lenses available. The service provider also enters into the business' patient database or the like, the information that the patient has completed on the “Lifestyle Packages” insert 32. Using the database or the like, an analysis is performed regarding what products and/or services would best meet the patent's individual vision needs, given the patient's activities and lifestyle, and this analysis is presented to the patient. The business may have a website on the internet, for example, having a plurality of web pages which relate to each category listed in the “Lifestyle Packages” insert 32. The patient data may also be placed on these web pages, printed and given to the patient. The web site and accompanying web pages are utilized and maintained by the clinic, for example. FIGS. 10-16 show specialty eyewear informational sheets 34-40 relating to lenses, frames and contact lenses recommended to bicyclers, golfers, etc. These specialty eyewear sheets are only examples, other such sheets may also be provided. The service provider will then assist the patient, in view of the patient's informed choices, with choosing lenses, frames and/or contacts. The service provider also reminds the patient to pick-up a “Fashion Consulting” insert 31, which encourages the patient to return to the optical area and meet with an optician to discuss frames and the selection of frames.

Referring to FIGS. 10-16, a catalog in print, a CD ROM with a video screen and computer with color printer and/or a website, as discussed above, is provided so that the clinic personnel is able to select the particular type and style of frames, lenses, contacts, etc. required depending upon the data entered by the patient on the “Lifestyle Packaging” insert 32. The input data will ultimately provide the patient to patient specific or the appropriate Specialty Eyewear sheets, video screens or web pages, as shown in FIGS. 10-16, however the patient may view and obtain any or all such informational sheets, screens and/or web pages if desired. In consultation with the optician, trained by the doctor, the description of the visual tasks enumerated on each sheet is reviewed and the proper frame(s), lens type(s) and/or contacts selection is made suitable and specific for the patient.

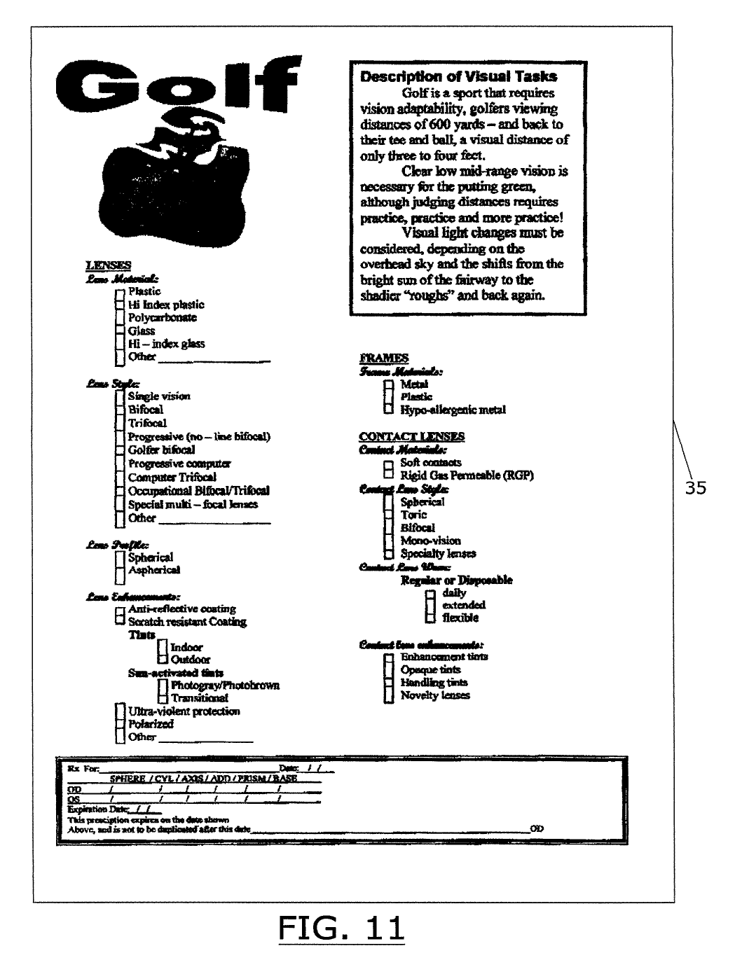

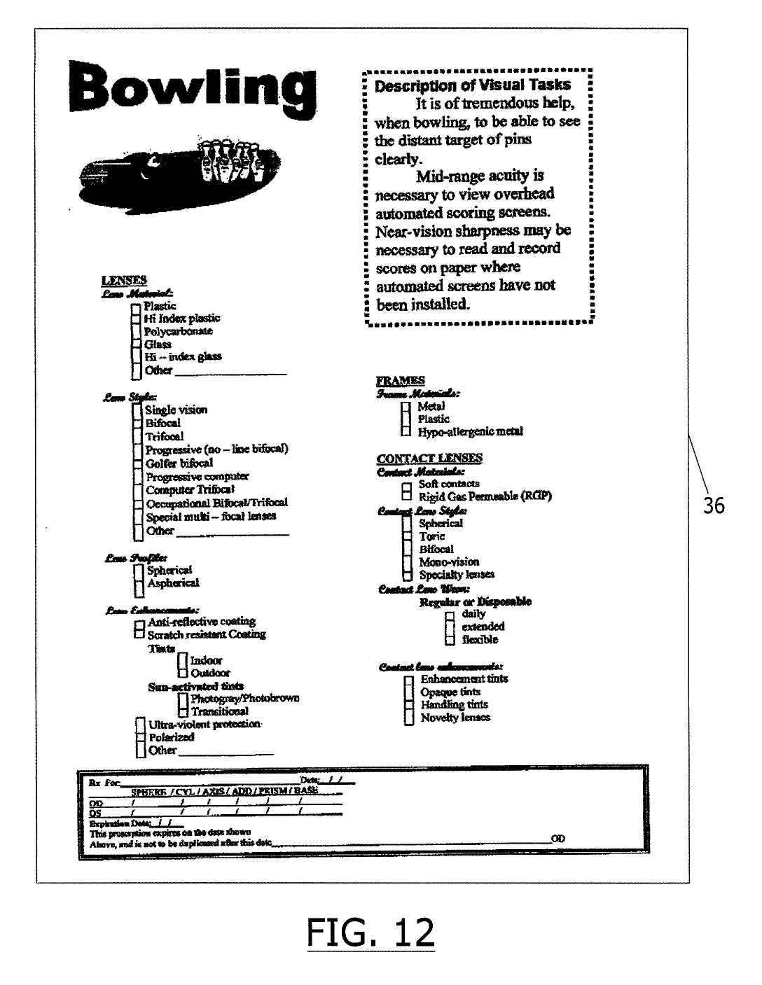

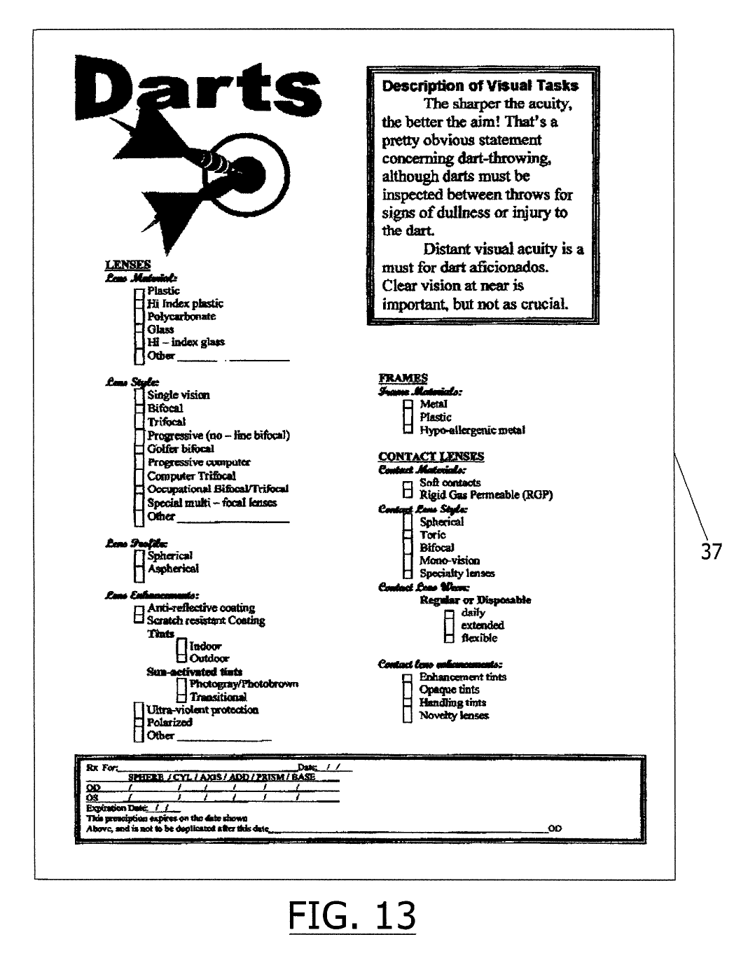

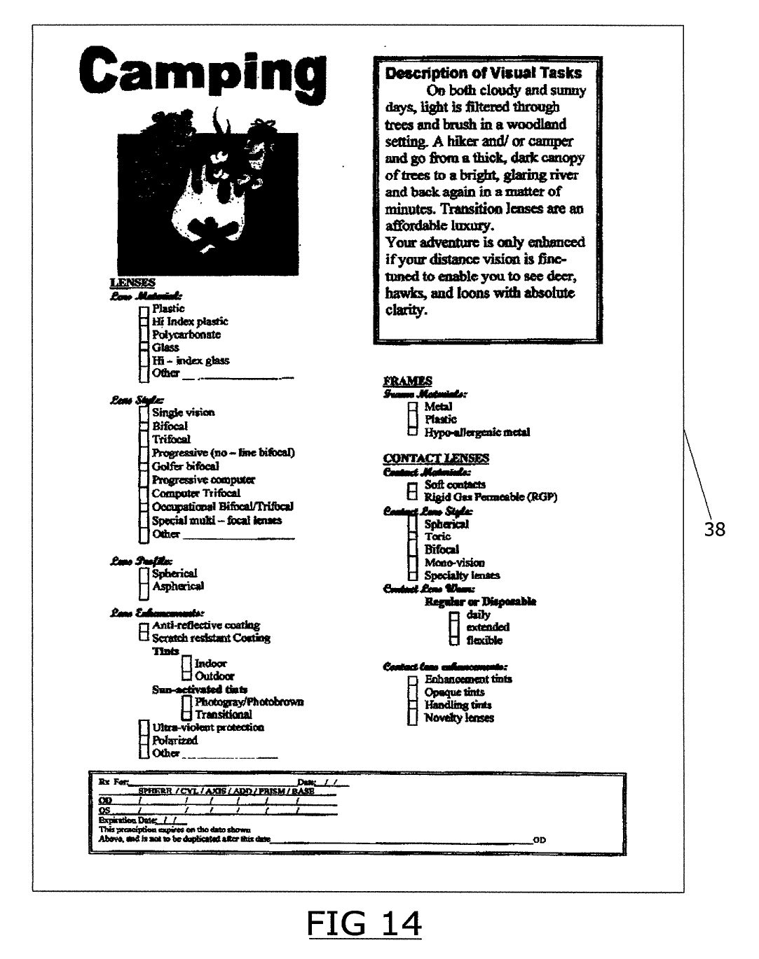

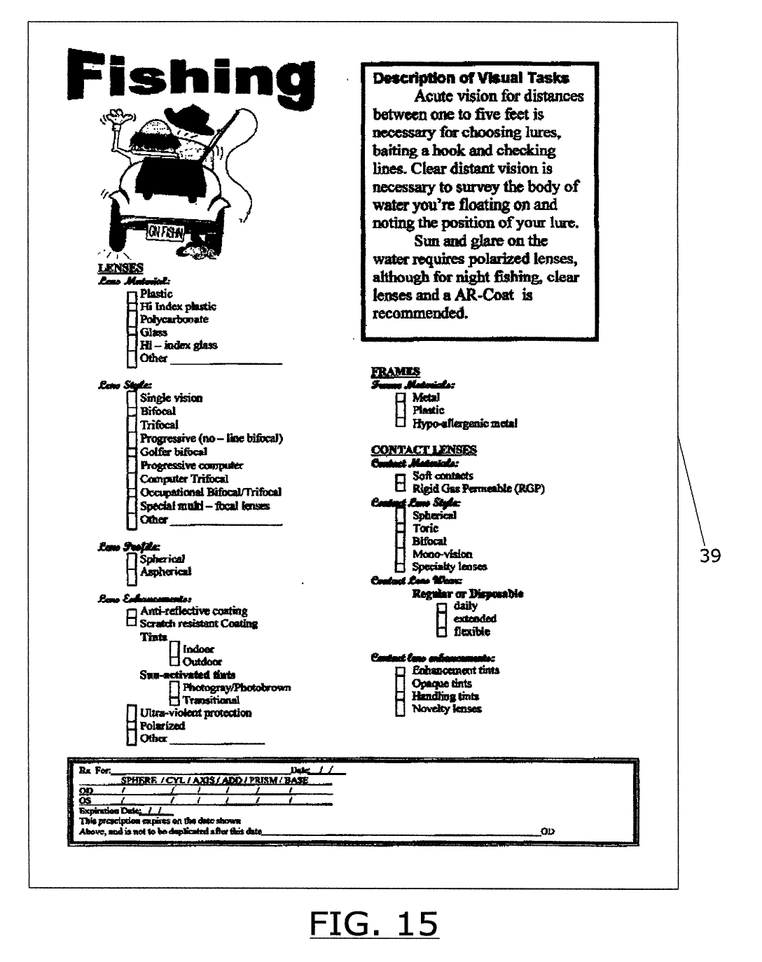

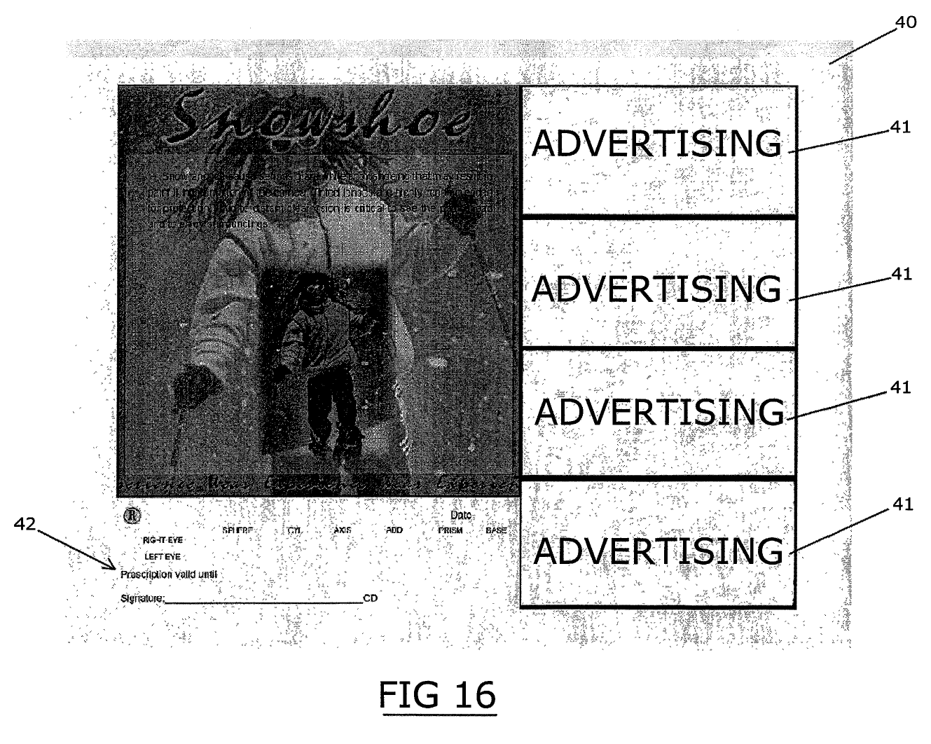

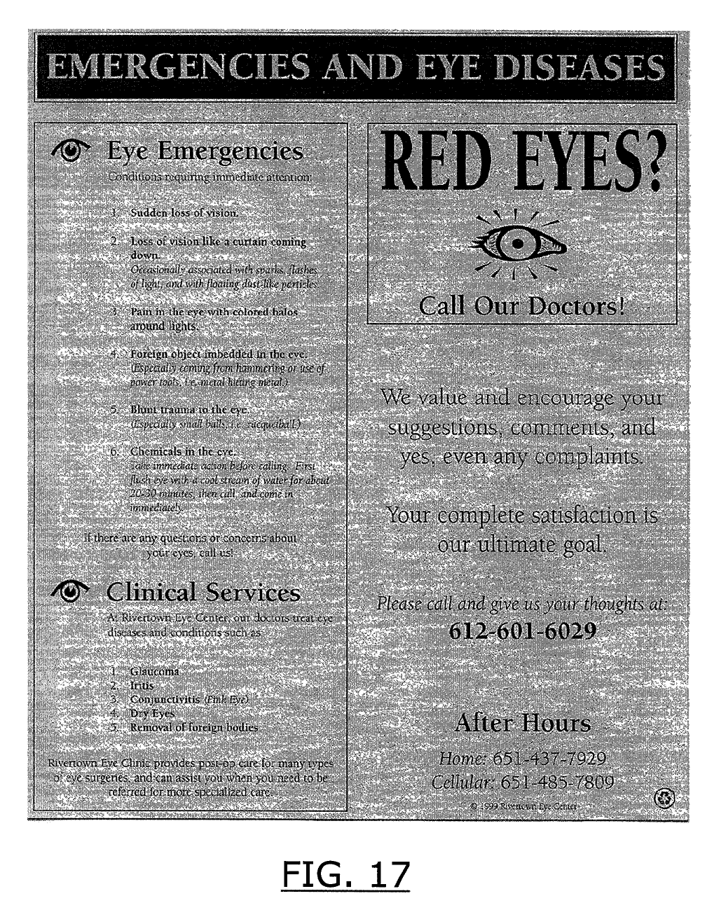

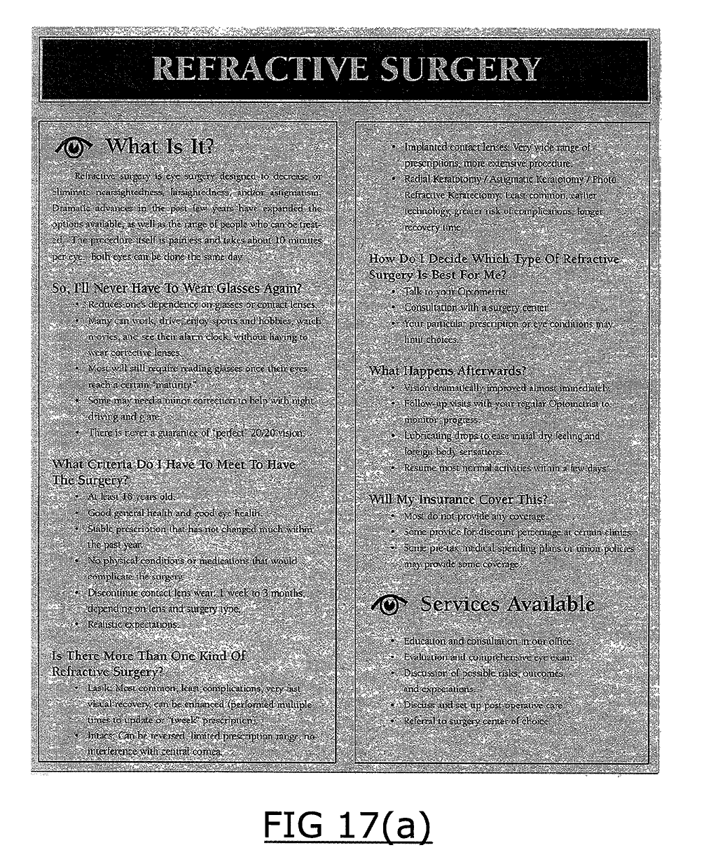

The specialty eyewear sheets shown in FIGS. 10-16 are as follows: FIG. 10 for bicycling (sheet 34), FIG. 11 for golf (sheet 35), FIG. 12 for bowling (sheet 36), FIG. 13 for darts (sheet 37), FIG. 14 for camping (sheet 38), FIG. 15 for fishing (sheet 39), and FIG. 16 for snowshoeing (sheet 40), however, other specialty eyewear informational sheets are also provided in the database, website, CD/ROM and/or the catalog. The specialty eyewear sheets shown in FIGS. 10-16 are exemplary. For example, all of the occupations and sports/recreation categories listed on insert 32 have companion sheets and further, other such sheets may also be provided within the purview of the invention.

Regarding the use of a website, the clinic consultant inputs the patient's name, date, prescription and expiration date, shown as prescription information 42 in FIG. 16. Next, an occupation or sports/recreation category is selected from a drop down box. Advertisements are next selected from designated drop down boxes, i.e., four such ads 41 may be selected as shown in FIG. 16. The “make it” button is clicked and the consultant previews the patient's specific printout and prints the web page. Finally, the consultant explains the printout and each advertisement with respect to the “lifestyle” selection. The advertisements 41, for example, may show frame, lens and/or contact styles and manufacturers which may be selected by the patient. The information, data, manner of use and advertisements are managed by the clinic and may be changed and modified as desired.

The consultant recommends specific frame, lens and contact types to the patient and which may involve several such recommendations depending upon the needs and requirements of the patient. For example, a patient may require several frame/lens and/or contact types to deal with various lifestyle requirements. The consultant initially enters the prescription onto the informational sheet(s) which is subsequently signed by the doctor.

When the patient returns to his or her physician for the eye test, and before the patient leaves the clinic, the physician presents the “Emergencies and Eye Diseases” insert 29. This insert educates the patient regarding eye conditions requiring immediate medical attention, the business' clinical services with respect to eye diseases and conditions, and the telephone numbers to call. The physician likewise reminds the patient to pick-up a “Fashion Consulting” insert 31 form the optical area.

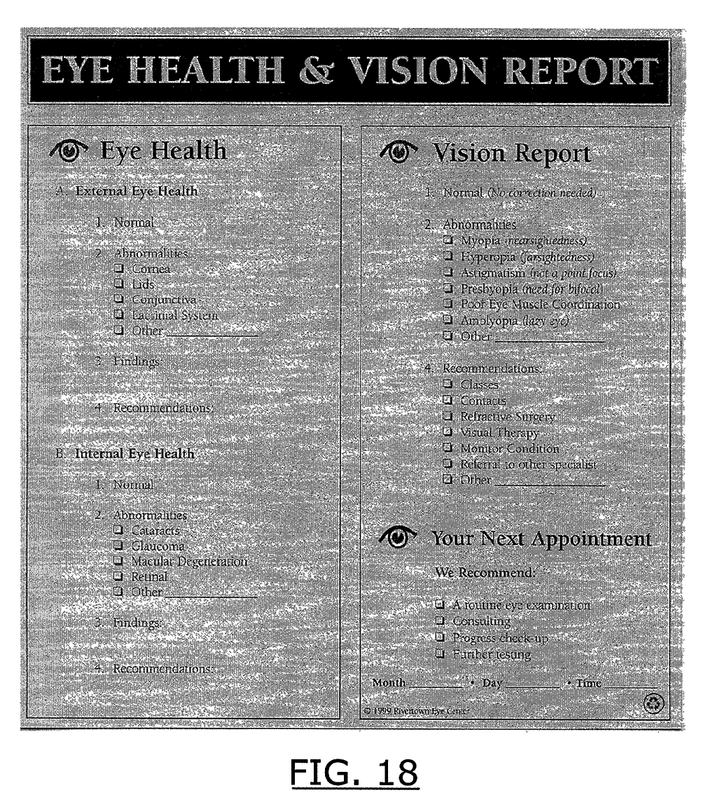

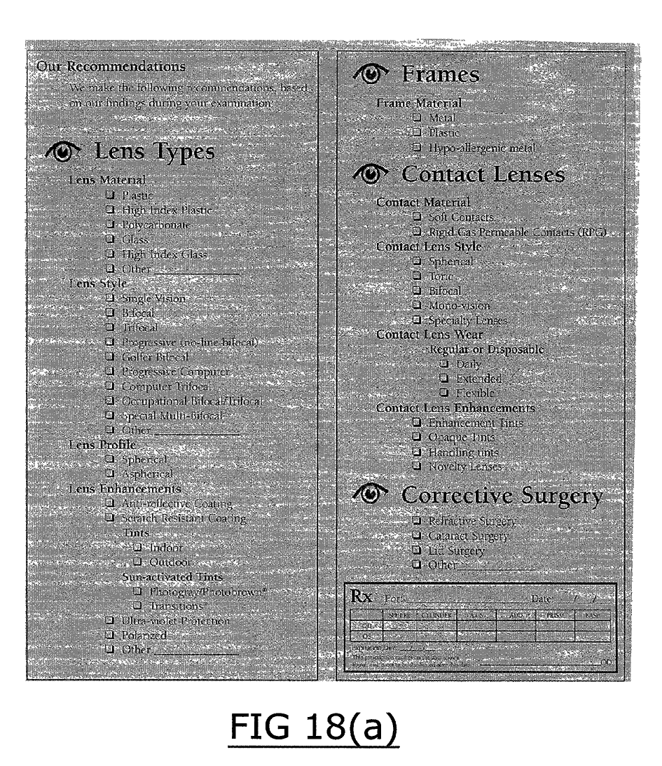

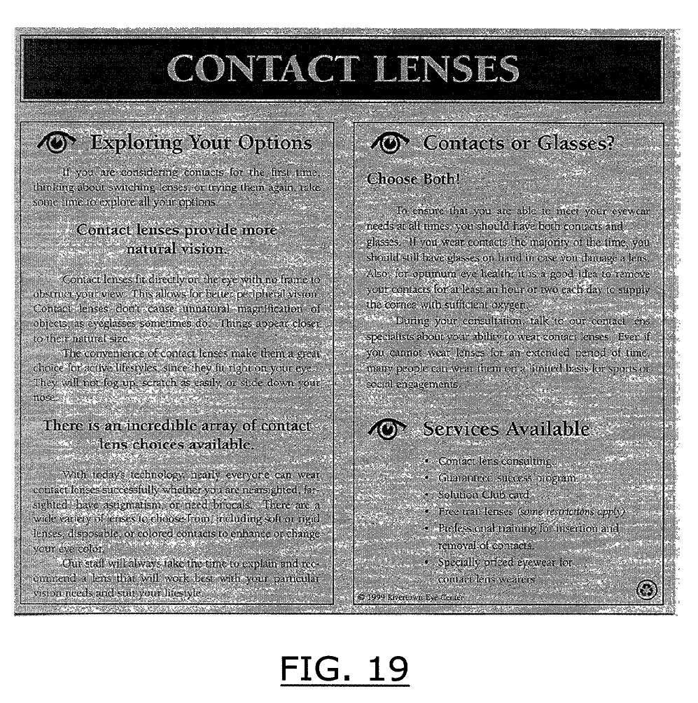

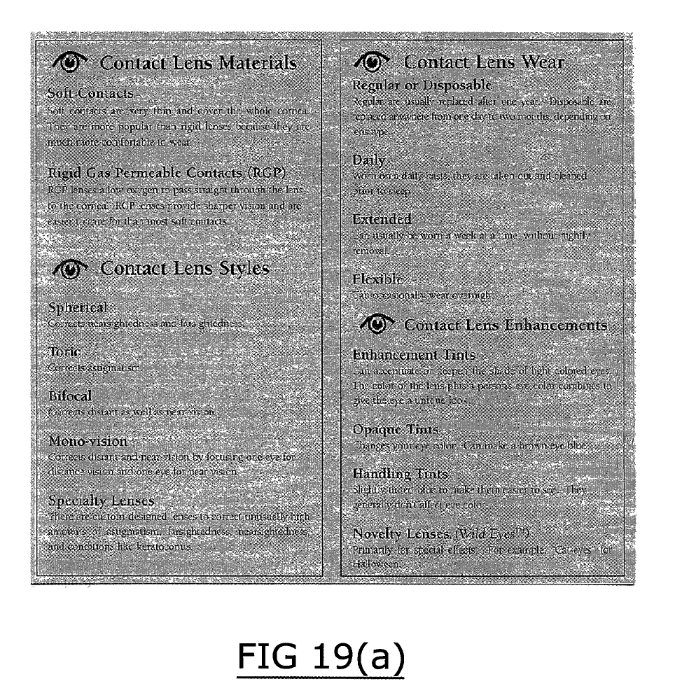

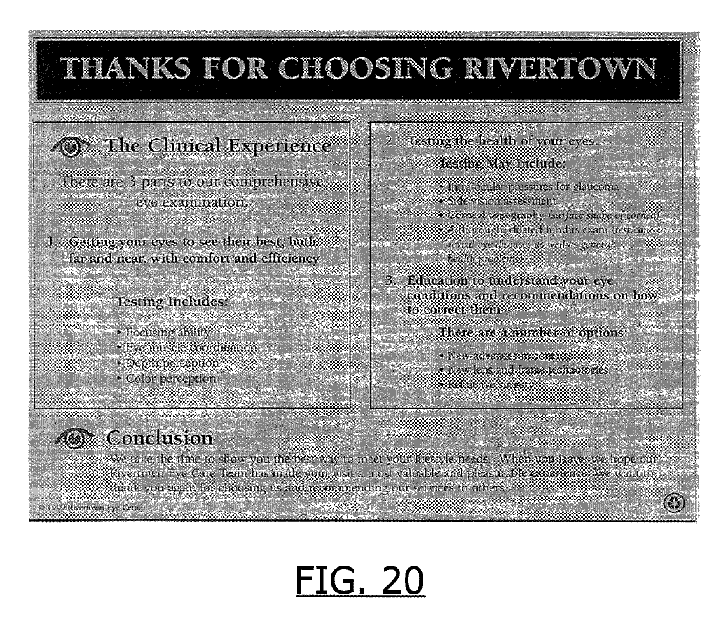

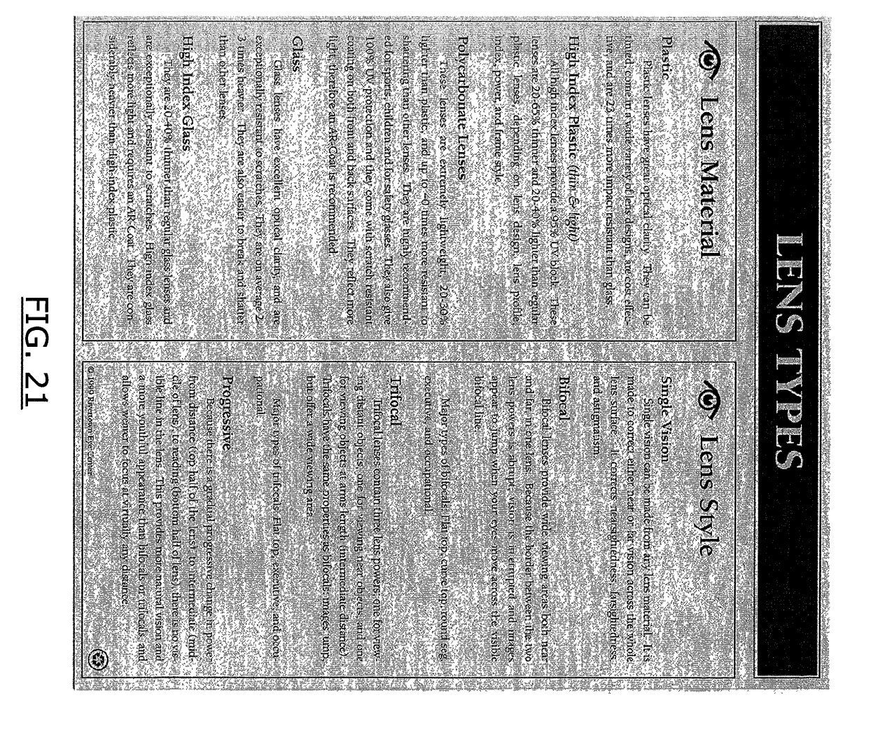

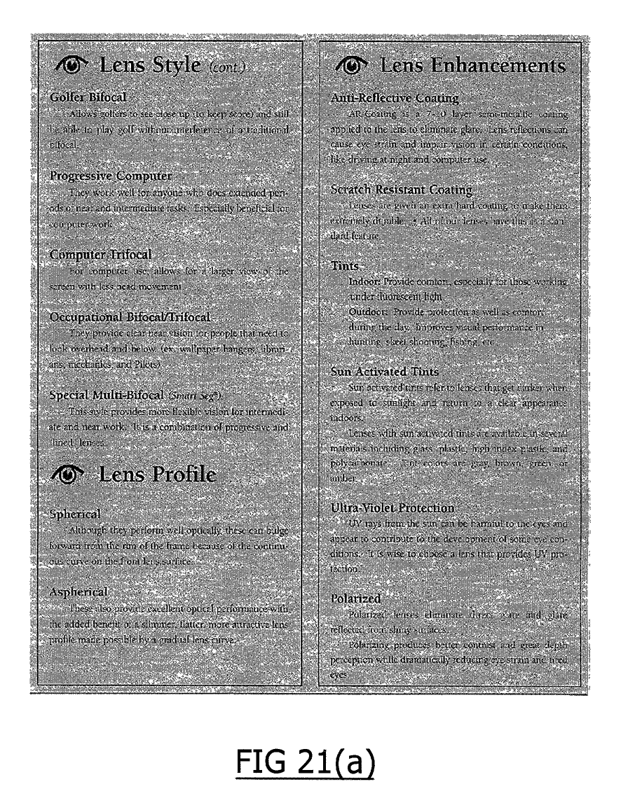

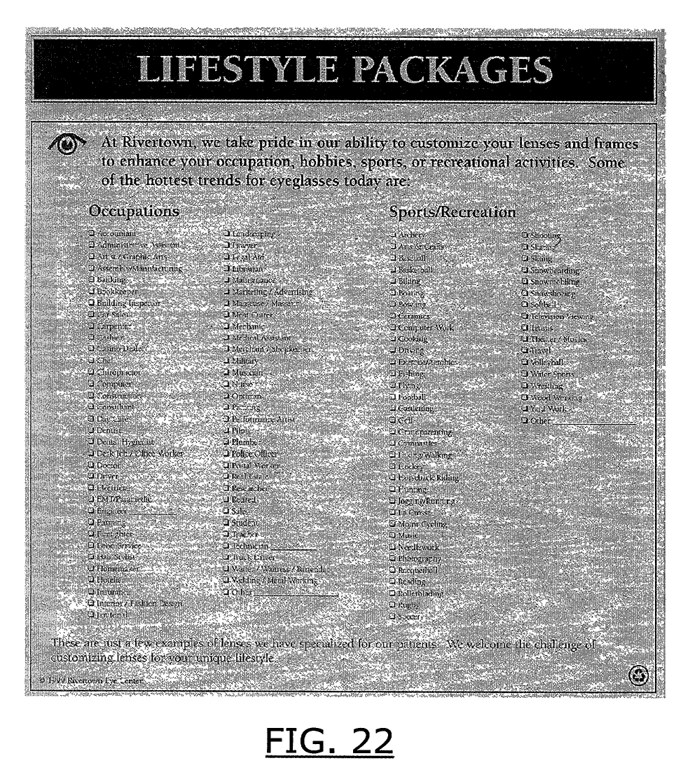

FIGS. 17-24 are enlarged views of the inserts shown and described with respect to FIGS. 2-9. Further, the back sides of FIGS. 17-19 and 21 are shown as FIGS. 17a, 18a, 19a and 21a. The inserts, therefore, may contain and provide a variety of information and may be updated as needed.

The method of the present invention relates to a business method and particularly to a method of doing business in the optometric field. The patient is provided with tangible information during the course of the visit which includes contact with the receptionist, the doctor and the optician. Specific information and data are exchanged between the parties and patient specific information is generated from a database or the like based upon the needs, requirements and information generated and obtained during the course of the visit.

The method of doing business includes and comprises the steps of a) contemporaneously with a visit from or to a customer for providing services to the customer, providing information to the customer regarding the business, the services and/or products offered by the business, and data generated during the visit, in an order that coincides with the order that the services are provided during the visit; b) contemporaneously with the visit, obtaining data and information from the customer prior to the time when the data will be useful in providing further services and/or products to the customer during the visit; c) prior to the time when the data will be useful in providing further services and/or products to the customer during the visit, entering into a database the data during the time services are provided and data is obtained from the customer; d) using the data entered into the database to perform an analysis regarding what products and/or services would best meet the customer's individual needs, prior to the time when the analysis will be useful in providing further services and/or products to the customer during the visit; e) presenting the analysis and the business' recommendations based on the analysis to the customer, prior to the time when the analysis will be useful in providing further services and/or products to the customer during the visit; and f) having the customer make a decision as to the products and/or services based on the analysis and information provided.

As many changes are possible to the methods of this invention utilizing the teachings thereof, the descriptions above are the accompanying drawings should be interpreted in the illustrative and not the limited sense.

That which is claimed is:

1. A method of doing business in an optometric clinic comprising the steps of:
a) providing an information holder to a patient in a clinic visit;
b) providing tangible information about the clinic to the patient for insertion in said informational holder;
c) obtaining patient related information from the patient during the clinic visit;
d) processing said patient information during said clinic visit;
e) performing an analysis during said clinic visit, said analysis to determine what clinic products and/or services are best suited for said patient based on said analysis;
f) presenting said analysis to said patient during said visit; and
g) performing said services and providing said products to said patient.

2. The method of doing business of claim 1, wherein said analysis is based on data and information input on the internet.

3. The method of claim 1, wherein step d) of said method is performed prior to step f) so that said analysis will be useful in providing further services and/or products to said patient.

4. The method of claim 1, wherein said information includes an information holder constructed and arranged to receive at least one business identification item and a plurality of tangible inserts.

5. The method of claim 4, wherein said at least one of business identification item includes a clinic business card and wherein said plurality of inserts have informational literature regarding said patient visit and said analysis.

6. The method of claim 4, wherein said at least one business identification item and said tangible inserts are arranged in said information holder to coincide with the order for providing the services that said patient receives at the clinic.

7. A method of doing business in a predetermined field, performed contemporaneously with a visit to or from a customer, and for providing services and products to said customer, said method comprising the steps of:
a) providing information to the customer regarding said business, wherein said business provides services and/or products, said information being provided in an order that coincides with the sequence that said services are provided during said visit;
b) obtaining data and information from said customer prior to the time that the data will be useful in providing further services and/or products to said customer during said visit;
c) entering said data into a database;
d) using said data entered into said database to perform an analysis regarding what products and/or services would best meet said customer's needs and to provide business recommendations; and
e) presenting the analysis and the business' recommendations based on said analysis to said customer.

8. The method of claim 7 wherein said analysis is based on data and information input on the internet.

9. The method of claim 7, wherein said information is provided by means of a tangible informational holder containing at least one business identification item and a plurality of inserts for placement in said informational holder.

10. The method of claim 7, wherein at least one business identification item and said plurality of inserts include at least one business card and various inserts containing informational literature regarding said visit and said analysis.

11. The method of claim 7, wherein said predetermined business is an optometric business.

12. The method of claim 11, wherein said informational literature includes a lifestyle packaging insert and an eye health and vision report insert.

13. An information holder for use in the optometric field comprising:
a) a folder having an interior and an exterior;
b) a first interior side and a second interior side, said first and second interior sides being located in said interior of said folder;
c) a first flap and a second flap, said first and second flaps extending along and from the bottom edge of said first and second interior sides, respectively, and said first and second flaps being for the containment of a plurality of inserts;
d) a plurality of angled slits contained in said first and second flaps, said slits being constructed and arranged for attachment of informational cards; and
e) a plurality of inserts, said inserts having varying heights and containing informational literature.

14. The information holder of claim 13, wherein said folder and said inserts describe the optometric field and an optometric clinic.

15. The information holder of claim 14, wherein said exterior of said folder contains the name of a specified clinic and wherein said inserts describe the nature of the services provided and the products distributed at said clinic distributing said holder.

16. The information holder of claim 13, wherein said folder is a unitary structure and is constructed of a material selected from the group of materials comprising construction paper, plastic and lightweight cardboard.

17. The information holder of claim 13, wherein said plurality of inserts have varying incremental heights and are arranged in said folder according to said incremental height.

18. The information holder of claim 13, wherein said folder is approximately 12 inches in height and approximately 9 inches in width when folded in half so that said first and second interior sides are facing each other and wherein said first and second flaps extend upwardly approximately 4.25 inches from the bottom of said first and second interior sides, respectively.

19. The information holder of claim 13, wherein said first and second flaps each have an outside edge and wherein said first and second interior sides each have an outside edge and wherein said outside edge of each said flap is united with said outside edge of each said interior side.

20. The information holder of claim 13, wherein said inserts include a lifestyle packaging insert and an eye health and vision report insert.
